(19) United States
(12) Patent Application Publication
(10) Pub. No.: US 2012/0226949 A1
(43) Pub. Date: Sep. 6, 2012

(54) Multi-Channel Bus Protection

(75) Inventors: Alexandre Pierre Palus, Sugar Land, TX (US); Karl Friedrich Greb, Missouri City, TX (US)

(73) Assignee: TEXAS INSTRUMENTS INCORPORATED, Dallas, TX (US)

(21) Appl. No.: 13/038,430

(22) Filed: Mar. 2, 2011

(51) Int. Cl. G06F 11/07

(52) U.S. Cl. 714/48; 714/E11.024

(57) ABSTRACT

An embodiment of the invention provides a method for managing errors on a bus. Information read from a source is encoded. The encoded information is transmitted on a channel that is part of the bus. The encoded information is evaluated. When no errors are detected, the decoded information is provided to a target. When the decoded information has an error or errors that can not be corrected, the source is asked to present the information to the bus again. When an error or errors can be corrected, the corrected information is sent to the target.

### BACKGROUND

Error detection and error correction are techniques that enable reliable delivery of digital data over unreliable communication channels. Error detection techniques allow detecting such errors while error correction enables reconstruction of the original data. Errors in digital data may occur during transmission of the digital data over a communications channel. A communication channel or channel refers either to a physical transmission medium containing one or more wires or to a logical connection over a multiplexed medium containing one or more wires.

A system-on-a-chip (SOC) or an embedded system may contain digital, analog, mixed-signal and often radio-frequency functions, all on a single chip substrate. A bus on an SOC or on an embedded system usually contains many channels. In SOCs and embedded systems, a typical system bus is a complex on-chip bus such as an AMBA (Advanced Microcontroller Bus Architecture) or a OCP (Open Chip Protocol) high-performance bus.

Because a complex bus contains many channels, errors may occur on the bus when the bus is used. For example, errors may occur on the bus when commands are send by a CPU (Central Processing Unit) to a memory element such as a SRAM (Static Random Access Memory) or a DRAM (Dynamic Random Access Memory). When the errors on the bus are not detected or corrected, an error may occur during the operation of the system.

An SOC or embedded system is a computer system often used to perform one or a few dedicated functions. Often these dedicated functions have real-time computing constraints where safety is an issue. For example, an SOC or an embedded system may be used to control the braking of an automobile. When an error occurs on a high-performance bus, the embedded system may lose control of the brakes and as a result cause harm to people who may be riding in the automobile. An embedded system or an SOC may also be used for applications such as controlling traffic lights, factories and nuclear power plants. Therefore it is important that errors on a bus be detected and/or corrected.

### BRIEF DESCRIPTION OF THE DRAWINGS

FIG. 1 is a block diagram of a computer system comprising a plurality of CPUs (central processing units), memory devices, peripheral devices and a bus. (Prior Art)

FIG. 2 is a block diagram showing embodiments of how to manage errors on a bus by encoding and decoding individual channels on a bus.

FIG. 3 is a block diagram of an embodiment of a computer system for managing errors on a bus comprising a plurality of CPUs (central processing units), memory devices, peripheral devices, a bus, encoding circuits and decoding circuits.

FIG. 4 is a block diagram of an embodiment of a computer system for managing errors on a bus comprising a plurality of CPUs (central processing units), memory devices, peripheral devices, a bus, encoding circuits and decoding circuits.

FIG. 5 is a flow chart illustrating an embodiment of a method of managing errors on a bus.

### DETAILED DESCRIPTION

The drawings and description, in general, disclose a method and system for managing errors that occur on a bus. In one embodiment, an address from a CPU is encoded to detect two errors and correct one error before it is presented on a bus. After the address is encoded, the encoded address is presented on the bus. The bus then presents the encoded address to circuitry that decodes the address.

When the decoded address has no errors, the decoded address is applied to an SRAM. In this example, when the encoded address has only one error, the error is corrected and the correct address is applied to the SRAM. However, when two errors are detected, both errors can not be corrected. In this case, no address is applied to the SRAM. A signal is sent through the bus to the CPU indicating that the address was corrupted. In this example, the CPU resends the address to the SRAM.

There are several ways that information (e.g. addresses, data, commands, responses) from a CPU, for example, may be encoded to detect an error that occurs on a channel in a bus. For example, a parity bit may be used to encode an address, data, or a command to detect a single error. A parity bit is a bit that is added to ensure that the number of bits with the value of one in a set of bits is even or odd. Parity bits are used as the simplest form of error detecting code.

There are two variants of parity bits: even parity bit and odd parity bit. When using even parity, the parity bit is set to 1 if the number of ones in a given set of bits (not including the parity bit) is odd, making the entire set of bits (including the parity bit) even. When using odd parity, the parity bit is set to 1 if the number of ones in a given set of bits (not including the parity bit) is even, keeping the entire set of bits (including the parity bit) odd. In other words, an even parity bit will be set to “1” if the number of 1's +1is even, and an odd parity bit will be set to “1” if the number of 1's +1 is odd.

There are several ways that information (addresses, data, commands, responses) from a CPU, for example, may be encoded to correct error(s) that occur on a bus. For example, an Error Correcting Code (ECC) may be used. ECC is a code in which data being transmitted or written conforms to specific rules of construction so that departures from this construction in the received or read data may be detected and/or corrected. Some ECC codes can detect a certain number of bit errors and correct a smaller number of bit errors. Codes which can correct one error are termed single error correcting (SEC), and those which detect two are termed double error detecting (DED). A Hamming code, for example, may correct single-bit errors and detect double-bit errors (SEC-DED). More sophisticated codes correct and detect even more errors. Examples of error correction code include Hamming code, Reed-Solomon code, Reed-Muller code and Binary Golay code.

In one embodiment of the invention, error(s) that occur on a OCP high-performance bus may managed. However, errors on other buses (e.g. AMBA, SBUS, ISA, Qbus etc.) may be managed as well. Other names for a bus include a switch, a bus matrix and an interconnect.

In SOCs and embedded systems, a typical system bus infrastructure is a complex on-chip bus such as an AMBA high-performance bus. AMBA defines two kinds of interfaces: master and slave. A slave interface is similar to programmed I/O through which the software (running on embedded CPU) can write/read I/O registers or (less commonly) local memory blocks inside the device. A master interface can be used by the device to perform DMA (direct memory access) transactions to/from system memory without heavily loading the CPU.

On-chip buses like an AMBA high-performance bus do not support tri-stating the bus or alternating the direction of any channel on the bus. In addition, no central DMA controller is required since the DMA is bus-mastering. However, an arbiter is required in case of multiple masters present on the system.

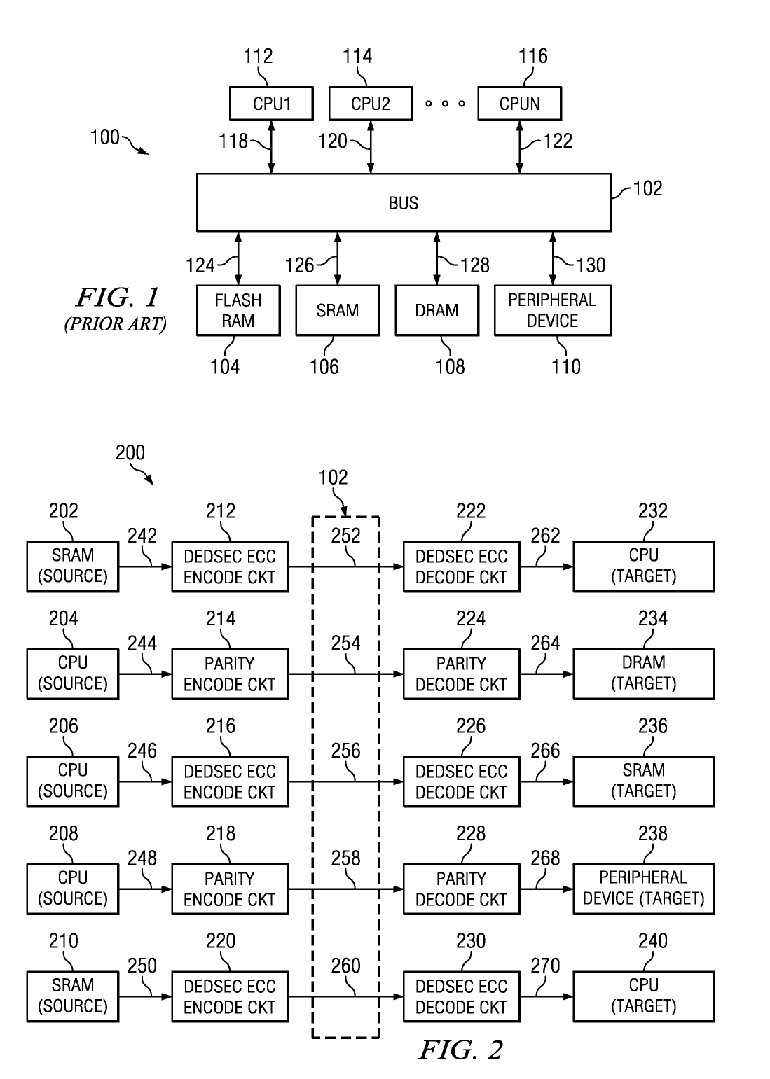

FIG. 1 is a block diagram of a computer system 100 comprising a plurality of CPUs (central processing units), memory devices, peripheral devices and a bus. Electrical connections 118, 120 and 122 make connection from CPUs 112, 114 and 116 respectively to the bus 102. Channels (not shown) in the bus 102 may be used to transmit information, for example, from CPU1 112 to a memory device such as an SRAM 106. The bus 102 may contain different types of channels. For example a bus 102 may contain a write address channel, a read address channel, a write data channel, a read data channel, a command channel (a command channel may include address information, size information and ordering information), and a response channel.

Electrical connections 124, 126 and 128 make connection from memory devices 104, 106 and 108 respectively to bus 102. Electrical connection 130 makes an electrical connection from a peripheral device 110 (e.g. a disk drive) to bus 102. Electrical connections 124, 126, 128, and 130 may be used to provide information (e.g. addresses, data, commands, responses etc.) to and from the bus 102. Channels (not shown) in the bus may be used to transmit information, for example, from peripheral drive 110 to a CPU such as CPU2 114.

In the example shown in FIG. 1, when an error occurs on a channel in the bus 102, the error can not be corrected. As a result, the system 100 may have an error that may cause safety problems.

FIG. 2 is a block diagram of embodiments of how to manage errors on a bus by encoding and decoding individual channels on the bus. In a first embodiment, data 242 from an SRAM (a source) 202 is encoded by a circuit 212 that uses ECC to detect for 2 errors (DED) and correct a single error (SEC) in bus 102. After the data 242 is encoded, the encoded data is applied to a data channel 252. The encoded data is a larger word because of the encoding. The number of extra bits added for ECC is determined by the particular algorithm used. The encoded data is then transmitted along the data channel 252 to a circuit 222 that decodes the encoded data. If there are no errors or a single error has been corrected, the decoded data 262 is received by the CPU (a target) 232. In the case where there is more than one error, a response may be sent back to SRAM 202 asking SRAM 202 to resend the data. If the SRAM 202 can not resend the data, an error will occur.

In a second embodiment, an address 244 from a CPU (a source) 204 is encoded by a circuit 214 that uses parity to detect a single error. The circuit 214 can not correct an error. After the address 244 is encoded, the encoded address is applied to a address channel 254 in the bus 102. The encoded address is a larger word because of the encoding. Parity usually creates 1 parity bit for every 8 bits. The encoded address is then transmitted along the address channel 254 to a circuit 224 that decodes the encoded address. If there are no errors, the decoded address 264 is received by the DRAM (a target) 234. When an error occurs, a response may be sent back to CPU 204 asking CPU 204 to resend the address. If the CPU 204 can not resend the address, an error will occur.

In a third embodiment, an address 246 from a CPU (a source) 206 is encoded by a circuit 216 that uses ECC to detect for 2 errors (DED) and correct a single error (SEC). After the address 246 is encoded, the encoded address 246 is applied to an address channel 256 in the bus 102. The encoded address is a larger word because of the encoding. The encoded address is then transmitted along the data channel 256 to a circuit 226 that decodes the encoded address. If there are no errors or a single error has been corrected, the decoded address 266 is received by the SRAM 236 (a target). In the case where there is more than one error, a response may be sent back to the CPU 206 asking the CPU 206 to resend the address. If the CPU 206 can not resend the data, an error will occur.

In a fourth embodiment, a command 248 from a CPU (a source) 208 is encoded by a circuit 218 that uses parity to a detect single error. The circuit 218 can not correct an error. After the command 248 is encoded, the encoded command is applied to a command channel 258 in the bus 102. The encoded command is a larger word because of the encoding. The encoded command is then transmitted along the command channel 258 to a circuit 228 that decodes the encoded command. If there are no errors, the decoded command 268 is received by the peripheral device (a target) 238. When an error occurs, a response may be sent back to CPU 208 asking CPU 208 to resend the command 248. If the CPU 208 can not resend the command 248, an error will occur.

In a fifth embodiment, a response 250 from an SRAM (a source) 210 is encoded by a circuit 220 that uses ECC to detect for 2 errors and correct a single error. After the response 250 is encoded, the encoded response is applied to a response channel 260 in the bus 102. The encoded response is then transmitted along the response channel 260 to a circuit 230 that decodes the encoded response. If there are no errors or a single error has been corrected, the decoded response 270 is received by the CPU (a target) 240. In the case where there is more than one error, a response may be sent back to SRAM 210 asking SRAM 210 to resend the response. If the SRAM 210 can not resend the response, an error will occur.

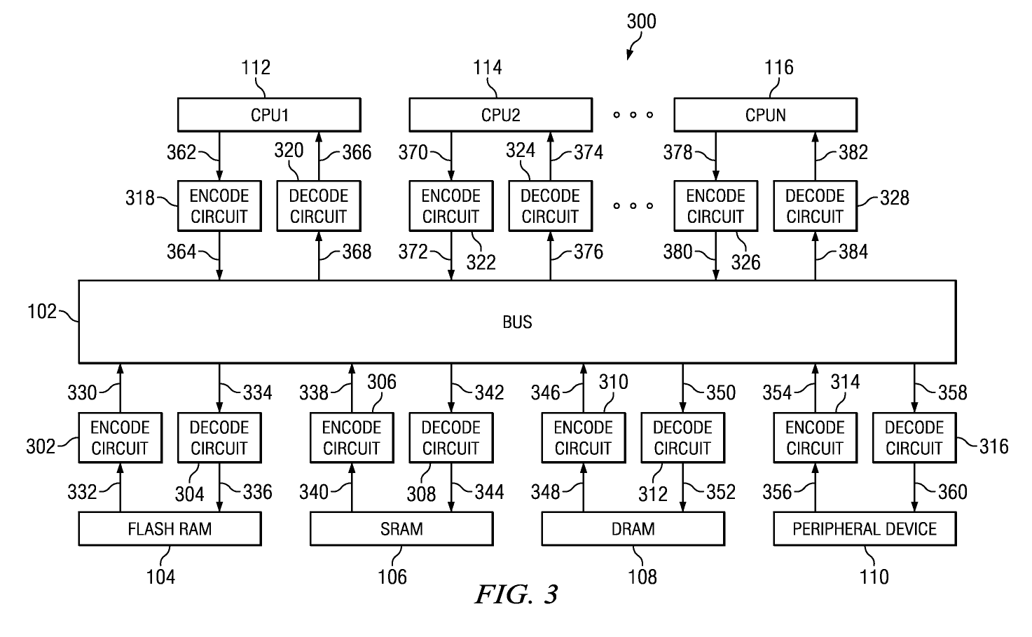

FIG. 3 is a block diagram of an embodiment of a computer system for managing errors on a bus comprising a plurality of CPUs, memory devices, peripheral devices, a bus, encoding circuits and decoding circuits. Electrical connections 362, 370 and 378 make connections from CPUs 112, 114 and 116 respectively to encode circuits 318, 322 and 326 respectively. Electrical connections 366, 374 and 382 make connections from decode circuits 320, 324 and 328 to CPUs 112, 114 and 116 respectively. Electrical connections 364, 372 and 380 make connection from encode circuits 318, 322 and 326 to the bus 102. Electrical connections 368, 376 and 384 make connections from the bus 102 to decode circuits 320, 324 and 328.

Electrical connections 332, 340, 348, and 356 make connections to encode circuits 302, 306, 310 and 314 respectively from the flash RAM 104, the SRAM 106, the DRAM 108, and the peripheral device 110 respectively. Electrical connections 336, 344, 352, and 360 make connections to the flash RAM 104, the SRAM 106, the DRAM 108, and the peripheral device 110 from the decode circuits 304, 308, 312, and 314 respectively. Electrical connections 330, 338, 346, and 354 make connections from encode circuits 302, 306, 310, and 314 to bus 102. Electrical connections 334, 342, 350 and 358 make connections from the bus 102 to decode circuits 304, 308, 312, and 316 respectively.

Electrical connections 364, 372 and 380 may be used to provide encoded information (e.g. addresses, data, commands, responses etc.) to the bus 102. Channels (not shown) in the bus may be used to transmit encoded information, for example, from CPU1 112 to a decoding circuit such as a decode circuit 304. The decoded information is transferred from the decode circuit 304 to the flash RAM 104. The bus 102 may contain different types of channels. For example a bus 102 may contain a write address channel, a read address channel, a write data channel, a read data channel, a command channel (a command channel may include address information, size information and ordering information), and a response channel.

In the embodiment shown in FIG. 3, CPUs 112-116, flash RAM 104, SRAM 106, DRAM 108, and peripheral device 110 may be either a source or a target.

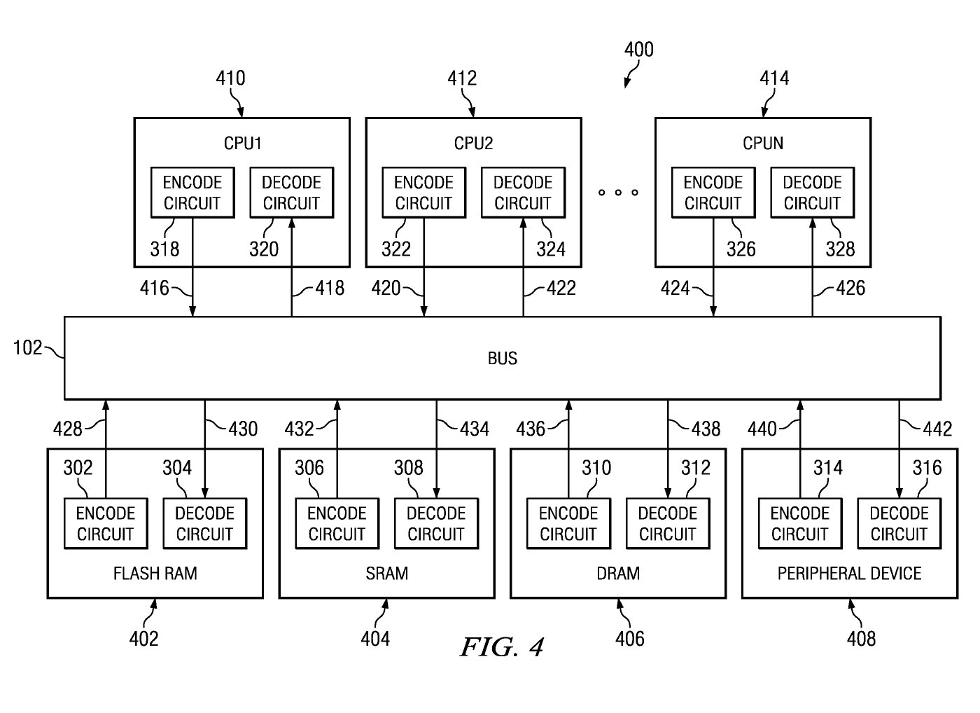

In the embodiment shown in FIG. 3, the encoders 318, 322, 326, 302, 306, 310, 314 and decoders 320, 324, 328, 304, 308, 312, 316 are physically separated from the bus 102, the CPUs 112, 114, 116, the memory devices 104, 106, 108, and the peripheral device 110. However, in another embodiment the encoders and decoders may be located in the CPUs, the memory devices and the peripheral device. This is illustrated in FIG. 4.

FIG. 4 is a block diagram of an embodiment of a computer system 400 for reducing errors on a bus comprising a plurality of CPUs, memory devices, peripheral devices, a bus, encoding circuits and decoding circuits. The embodiment shown in FIG. 4 is similar to the embodiment shown in FIG. 3. In the embodiment shown in FIG. 4, the encode circuits 318, 322, 336, 302, 306, 310, 314 and the decod circuits 320, 324, 328, 304, 308, 312, 316 are physically located in the CPUs 410, 412, 414, the memory elements 402, 404, 406 and the peripheral device 408.

When information, for example, is sent from CPU1 410, the information is already encoded. The information is encoded by an encode circuit 318 that is physically part of the CPU1 410. When the encoded information reaches its target, for example, the SRAM 404, the encoded information is decoded by a decode circuit 308 that is physically part of the SRAM 404.

In the embodiment shown in FIG. 3, CPUs 410-414, flash RAM 402, SRAM 404, DRAM 406, and peripheral device 408 may be either a source or a target.

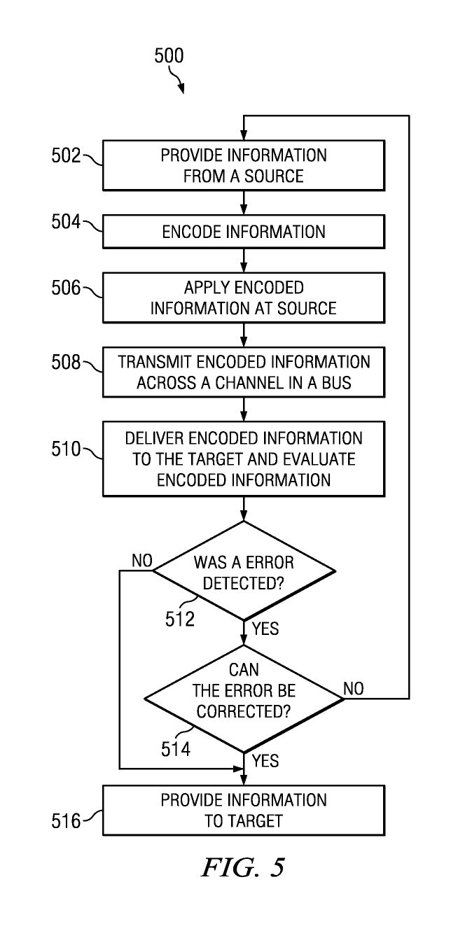

FIG. 5 is a flow chart illustrating an embodiment of a method of managing errors on a bus. Information is provided during step 502. Information, for example, may be an address, data, a command, or a response for example. A source can be a CPU, a memory element (e.g. DRAM, SRAM etc.) or a peripheral device for example. Step 504 encodes the information provided from the source. Encoding may be done using parity or ECC for example. After the information is encoded, it is applied at the source.

During step 508, the encoded information is transmitted across a channel that is part of a bus. A channel may be a write address channel, a read address channel, a write data channel, a read data channel, a command channel (a command channel may include address information, size information and ordering information), and a response channel. The encoded information is then delivered to the target and the encoded information is evaluated.

When no error is detected the information is provided to the target as shown in step 516. A target may include a CPU, a memory element (e.g. DRAM, SRAM etc.) or a peripheral device for example. When an error or errors are detected that can not be corrected, a signal is sent that asks the source to provide the information again as shown in step 514. When an error or errors can be corrected, they are corrected and the decode information is provided to a target as shown in step 516.

The foregoing description has been presented for purposes of illustration and description. It is not intended to be exhaustive or to limit the invention to the precise form disclosed, and other modifications and variations may be possible in light of the above teachings. The embodiments were chosen and described in order to best explain the applicable principles and their practical application to thereby enable others skilled in the art to best utilize various embodiments and various modifications as are suited to the particular use contemplated. It is intended that the appended claims be construed to include other alternative embodiments except insofar as limited by the prior art.

What is claimed is:

1. A method for managing errors on a bus comprising:
providing information from a source;
encoding the information;
applying the encoded information at the source;
transmitting the encoded information across a channel wherein the channel is part of the bus;
delivering the encoded information to a target;
evaluating the encoded information;
providing the information to the target when no errors were detected on the channel or all error(s) were corrected;
notifying the source that the information is corrupted when error(s) are detected on the channel and all the error(s) can not be corrected.

2. The method of claim 1 wherein information is selected from a group consisting of addresses, data, commands, and responses.

3. The method of claim 1 wherein the source is selected from a group consisting of a CPU, an SRAM, a DRAM, a FLASH RAM, and a peripheral device.

4. The method of claim 1 wherein the target is selected from a group consisting of a CPU, an SRAM, a DRAM, a FLASH RAM, and a peripheral device.

5. The method of claim 1 wherein the channel is selected from a group consisting of a write address channel, a read address channel, a write data channel, a read data channel, a command channel, and a response channel.

6. The method of claim 1 wherein the bus is an AM BA (Advanced Microcontroller Bus Architecture) bus.

7. The method of claim 1 wherein the bus is an OCP (Open Chip Protocol) bus.

8. The method of claim 1 wherein encoding is performed using parity error detection.

9. The method of claim 8 wherein decoding is performed using odd parity.

10. The method of claim 8 wherein decoding is performed using even parity.

11. The method of claim 8 wherein parity error detection comprises using one parity bit per eight bits of data.

12. The method of claim 1 wherein the encoding and the decoding is performed using a double-error-detect-single-error-correct (DEDSEC) error correction code.

13. The method of claim 1 wherein the encoding and the decoding is performed using a single-error-correct (SEC) error correction code.

14. The method of claim 1 wherein the encoding and decoding is performed using a code selected from a group consisting of a Hamming code, a Reed-Solomon code, a Reed-Muller code and a Binary Golay code.

15. A computer system for managing errors on a bus comprising:
a source of information;
a target;
wherein the bus has at least one channel;
wherein information from the source is encoded;
wherein the encoded information transmitted over the at least one channel is evaluated before applying the information to the target.

16. The computer system of claim 15 wherein the source is selected from a group consisting of a CPU, an SRAM, a DRAM, a FLASH RAM and a peripheral device.

17. The computer system of claim 15 wherein the target is selected from a group consisting of a CPU, an SRAM, a DRAM, a FLASH RAM and a peripheral device.

18. The computer system of claim 15 wherein the at least one channel is selected from a group consisting of a write address channel, a read address channel, a write data channel, a read data channel, a command channel, and a response channel.

19. The computer system of claim 15 wherein the at least one bus is an Open Chip Protocol bus.

20. The computer system of claim 15 wherein the bus is an on-chip bus.
